(19) United States
(12) Patent Application Publication
(10) Pub. No.: US 2018/0129712 A1
(43) Pub. Date: May 10, 2018

(54) DATA PROVENANCE AND DATA PEDIGREE TRACKING

(71) Applicant: CA, Inc., New York, NY (US)

(72) Inventor: Serguei Mankovskii, Morgan Hill, CA (US)

(21) Appl. No.: 15/346,958

(22) Filed: Nov. 9, 2016

(51) Int. Cl. G06F 17/30; H04L 29/06

(52) U.S. Cl. CPC G06F 17/30516; G06F 17/30339; H04L 65/60; G06F 17/30864

(57) ABSTRACT

A data provenance and pedigree tracking system may collect, store, and process monitoring data collected by correlators. Monitoring data collected by correlators are events that associate data pedigree, usage rules, and provenance events. Data monitoring may be performed on the data processing and storage functions invoked when performing data analytics for example. The system can determine, maintain and persist association among components, events, rules etc. that contributed to generating a data object result. For example, a data provenance and pedigree tracking system can calculate the total cost of processing the data by adding the processing cost of each component.

### BACKGROUND

The disclosure generally relates to the field of data processing, and more particularly to data management.

Big data processing and analytics are an increasingly important aspect of modern computing. Organizations are relying on insights derived from big data to aid in decision-making, identify cost reduction opportunities, etc. As the impact and importance of big data analysis affect an organization's growth and/or day to day operations, organizations are devoting considerable resources to gathering and analyzing data.

### BRIEF DESCRIPTION OF THE DRAWINGS

Aspects of the disclosure may be better understood by referencing the accompanying drawings.

FIG. 1 depicts a representative data provenance and pedigree tracking system executing a data analytics request.

FIG. 2 depicts a more detailed representation of a tracking system executing a data analytics request.

FIG. 3 depicts an example portion of a streaming manager data store.

FIGS. 4 and 5 depict flowcharts for executing data set processing.

FIG. 6 depicts an example computer system with a data provenance and pedigree tracking system.

### DESCRIPTION

The description that follows includes example systems, methods, techniques, and program flows that embody aspects of the disclosure. However, it is understood that this disclosure may be practiced without these specific details. For instance, this disclosure refers to a distributed big data framework in illustrative examples. Aspects of this disclosure can also be applied to other data processing and storage systems such as non-relational databases. In other instances, well-known instruction instances, protocols, structures, and techniques have not been shown in detail in order not to obfuscate the description.

Introduction

Determination of the veracity and/or timeliness of data may depend on the ability to determine information regarding the data (e.g., metadata), such as the origin of the data, what processes transformed the data, on what authority the data was transformed, whether the data was generated from other data, whether there is any usage restriction on data, etc. Organizations also use such information to account for the costs involved in performing data analysis.

Overview

Data provenance and pedigree include information regarding data origin, processing history, processing rights, and rules associated with the data throughout a data processing and storage pipeline to establish: a) a chain of processing stages from the origin of the source data to one or more derived data artifacts (i.e., data pedigree), b) whether processing was performed according to specified rules such as restrictions imposed by the owner of the source data (i.e., usage rules), and c) whether the processing stages or functions complied with data derivation rules such as limitations on generation and storage of derived data from the source data and/or intermediate data artifacts (i.e., data provenance).

A data provenance and pedigree tracking system (hereinafter “tracking system”) may collect, store, and process monitoring data collected by correlators. Monitoring data are collected by correlators as events that associate data pedigree, usage rules, and provenance events. Data monitoring may be performed on the data processing and storage functions invoked when performing data analytics for example. The system can determine, maintain, and persist association among components, events, rules, etc. that contributed to generating a data object result. For example, a data provenance and pedigree tracking system can calculate the total cost of processing the data by adding the processing cost of multiple components.

Example Illustrations

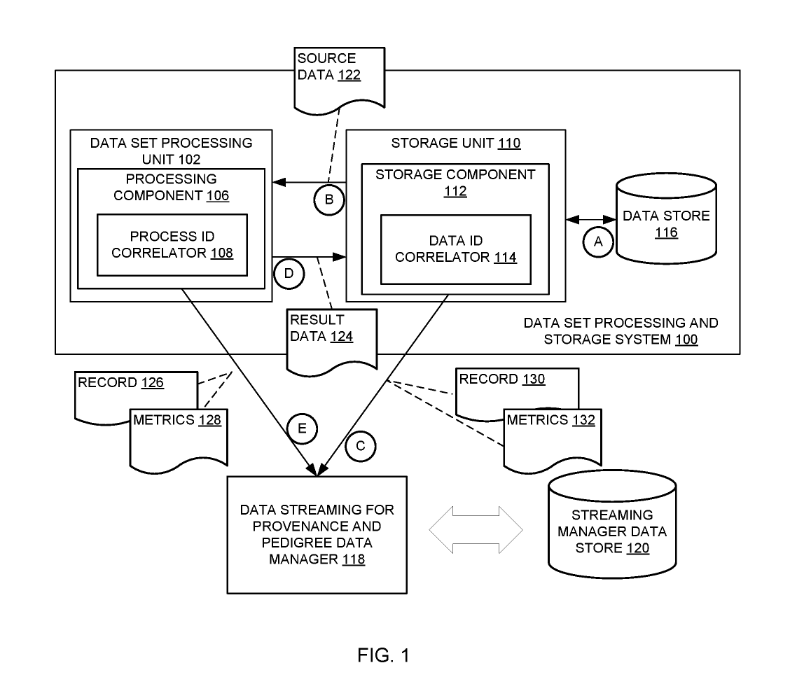

FIG. 1 depicts a representative data provenance and pedigree tracking system (hereinafter “tracking system”) executing a data set processing request. The tracking system comprises a data set processing and storage system 100, a big data streaming for provenance and pedigree data manager (hereinafter “streaming manager”) 118, and a streaming manager data store 120. The tracking system tracks the movement of data through the system 100 by monitoring and recording processing stage information in conjunction with data artifact information. To this end, the tracking system may monitor and record pedigree components (e.g., processing components) and provenance components (e.g., data artifact components) such as date/time the data was generated, stored, retrieved, and/or processed, etc. The system 100 executes data processing functions such as storing and analyzing big data. The system 100 comprises a data set processing unit 102, a storage unit 110, and a data store 116. The system 100 may be a cluster of machines that may number in the thousands. The processing unit 102 comprises one or more non-storage data processing components such as a processing component 106. The processing unit 102 may be one of several computing paradigms used in large scale data analytics such as MapReduce, spanning tree, bulk synchronous parallel (BSP), and directed acyclic graph (DAG). The pedigree component 106 is loaded with a process ID correlator 108. The storage unit 110 manages generation, storage, and availability of data for processing. The storage unit may be one of several big data storage and management systems such as a distributed file system (DFS), a NoSQL database, etc. The storage unit 110 includes/hosts a storage component 112 that is loaded with a data identifier (ID) correlator 114. The correlators 108 and 114 may be daemons that collect and transmit information to the streaming manager 118. Upon receipt of the information, the streaming manager 118 stores the information in the streaming manager data store 120.

FIG. 1 is annotated with a series of letters A-E. These letters represent stages of operations. Although these stages are ordered for this example, the stages illustrate one example to aid in understanding this disclosure and should not be used to limit the claims. Subject matter falling within the scope of the claims can vary with respect to the order of some of the operations.

At stage A, upon request by the processing component 106 of the processing unit 102, the provenance component 112 of the provenance unit 110 retrieves a source data 122 from the data store 116. The provenance unit 110 manages the data stored in the data store 116. For example, the provenance unit 110 determines compliance of data derivation rules (e.g., limitations on generation of a target data (e.g., result data), wherein the target data is derived from a source data and/or an intermediate data). The provenance unit 110 comprises at least one provenance component each executing code to execute a function. The provenance components can be located remotely from one another or co-located. One or more of the provenance components may be loaded with a data ID correlator, such as the data ID correlator 114. A correlator is programmed to detect and correlate various events executed related to servicing a request. The correlator includes an agent that monitors the various events. The data ID correlator 114 tracks source data IDs and generates source data IDs as data objects are accessed by provenance components and/or as new data objects are stored. In addition, the data ID correlator 114 may execute tasks such as determining whether a source data has an associated owner ID. In this example, the provenance component 112 is loaded with the data ID correlator 114.

The data request by the processing component 106 contains a function call to the provenance component 112 to retrieve the source data 122 from the data store 116. The data store 116 contains a homogeneous or heterogeneous data set. The heterogeneous data set may be comprised of structured, semi-structured, and unstructured data (e.g., text files, spreadsheets, emails, social media posts, graphs, geospatial data). The function call contains a script to read data from the data store 116. The function call also contains an ID (e.g., a P_GUID) of the invoking component (i.e., the processing component 106). The invoking entity's unique ID may also be generated and/or determined by a process ID correlator loaded in the processing component. The invoking entity's P_GUID may be used to determine the lineage or derivation history of the source data 122 by tracking its movement through the storage and/or processing pipeline. The processing pipeline comprises one or more processing components that perform functions on and/or transforms the source data that that have been determined to be included in a pedigree processing set. The storage pipeline is comprised of provenance and/or storage components that perform functions (e.g., serialize, deserialize), store, retrieve, etc. on data (e.g., source data, result data).

At stage B, the provenance component 112 transmits the retrieved source data 122 to the processing component 106 of the processing unit 102 for analysis and/or processing. The provenance component 112 may execute pre-processing procedures to the source data 122 before transmission or providing it to the processing component 106. For example, if the source data 122 is a comma-separated values (CSV) file, the provenance component 112 may remove any markup data such as headers and footers from the CSV file before transmitting the source data 122. In another example, the provenance component 112 may direct another component (e.g., pre-processing component) to pre-process the source data 122.

At stage C, the data ID correlator 114 determines a unique ID (i.e., D_GUID_SOURCE) for the source data 122. The data ID correlator 114 may determine the D_GUID_SOURCE by applying a hash function to the requested source data 122. The data ID correlator 114 associates the D_GUID_SOURCE of the source data 122 to an ID of an entity that has ownership rights (i.e., OWNER_ID) according to usage rules of the source data 122. The OWNER_ID may, for example, be determined from the metadata of the source data 122. The data ID correlator 114 transmits the D_GUID_SOURCE and the OWNER_ID in association as a record 130 to the streaming manager 118. The data ID correlator 114 monitors and collects metrics 132 from the provenance component 112 while the provenance component 112 retrieves and transmits the source data 122 to the processing component 106. The data ID correlator 114 transmits the collected metrics 132 to the streaming manager 118. The streaming manager 118 stores the record 130 associating D_GUID_SOURCE and the OWNER_ID in addition to the metrics 132 in the streaming manager data store 120. The streaming manager 118 uses stream-based processing techniques when processing transmitted data.

At stage D, the processing component 106 processes the source data 122 and transmits the output (i.e., a result data 124) to the provenance component 112. At stage E, the process ID correlator 108 associates the P_GUID with a processor ID of the processing component 106 in a record 126. The process ID correlator 108 monitors and collects metrics 128 from the processing component 106 while the processing component 106 processes the source data 122. The process ID correlator 108 transmits the record 126 and the collected metrics 128 to the streaming manager 118. The streaming manager 118 stores the record 126 and the metrics 128 received in the streaming manager data store 120.

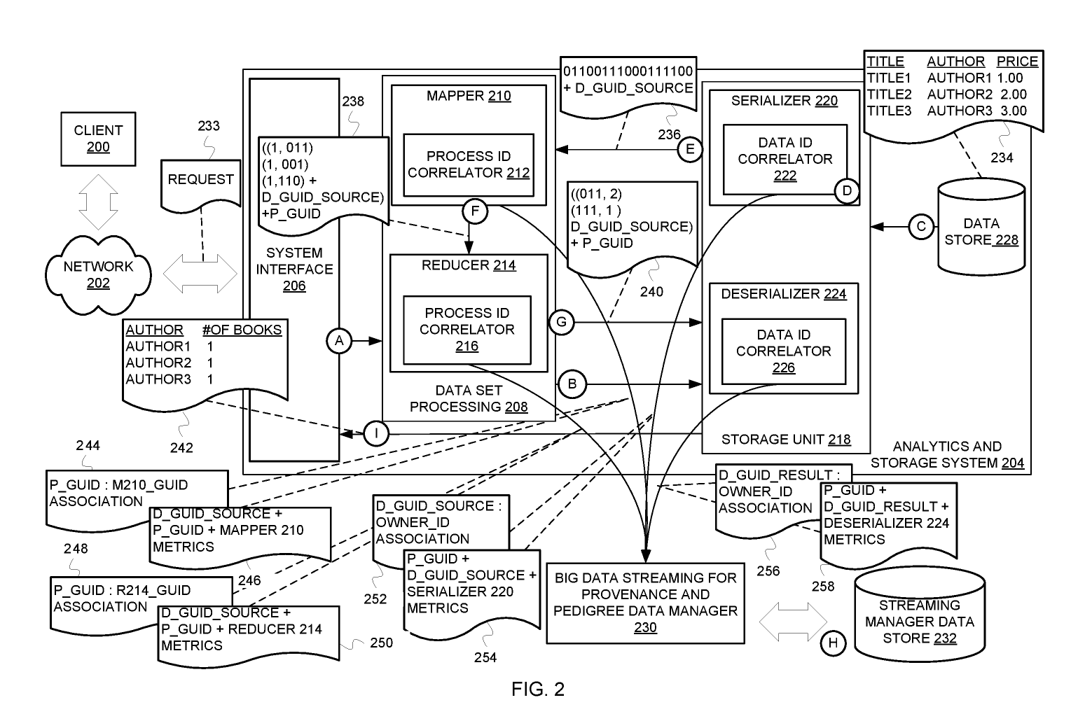

FIG. 2 depicts a more detailed representation of a tracking system executing a data analytics request. The tracking system comprises a data analytics and storage system (hereinafter “analytics system”) 204, a streaming manager 230, and a streaming manager data store 232. The analytics system 204 comprises a processing unit 208, a provenance unit 218, and a data store 228. The processing unit 208 (e.g., processing unit) comprises an implementation of a MapReduce data processing paradigm. MapReduce is a programming model for processing and generating large data sets on a cluster. The processing unit 208 hosts a mapper 210 and a reducer 214 that operate to implement the MapReduce functions. The mapper 210 is loaded with a process ID correlator 212, and the reducer 214 is loaded with a process ID correlator 216. The provenance unit 218 (e.g., storage unit) utilizes a serializer-deserializer (SERDES) infrastructure for retrieving and storing data. The provenance unit 218 hosts a serializer 220 and a deserializer 224. The serializer 220 converts data into a data stream for transmission. The deserializer 224 converts a data stream into the original format of the serialized data for storage and/or reports. The serializer 220 is loaded with a data ID correlator 222, and the deserializer 224 is loaded with a data ID correlator 226. The correlators 212, 216, 222, and 226 collect and transmit information to the streaming manager 230. The streaming manager 230 stores the information in the streaming manager data store 232.

FIG. 2 is annotated with a series of letters A-I. These letters represent stages of operations. Although these stages are ordered for this example, the stages illustrate one example to aid in understanding this disclosure and should not be used to limit the claims. Subject matter falling within the scope of the claims can vary with respect to the order of some of the operations.

At stage A, a system interface 206 receives a request 233 from a client 200 via a network 202 and invokes the processing unit 208 to start processing the request 233. The client 200 may be a resource, application and/or user that requests services from the analytics system 204. The system interface 206 accepts requests from various sources such as the client 200. The requests may comprise various application data analysis requests such as to identify patterns, to mine data, to assess a number of page views, etc. The request 233 may include metadata that indicates resources associated with the request (e.g., input data, processor IDs, owner of the request, etc.). The request metadata may also indicate the priority, dependencies on other requests, and other information describing attributes of the request and/or entities initiating the request. With this information, the system interface 206 processes the request 233 to determine an execution plan in servicing the request 233. For example, the system interface 206 may transmit the request 233 to a compiler (not depicted) to translate the request into queries (e.g., Hive Query Language (HiveQL®) statements) and MapReduce jobs for execution. The processing unit 208 will then be invoked to start servicing the request based on the execution plan.

At stage B, the processing unit 208 invokes the provenance unit 218 to retrieve data from the data store 228 for processing. The provenance unit 218 manages the data stored in the data store 228. The provenance unit 218 may include one or more components, each component executing code to execute a function. The components may be located remotely from one another or co-located. The components are loaded with data ID correlators. The provenance unit 218 components (e.g., the serializer 220 and the deserializer 224) manage and/or track the data IDs and generates IDs via the data ID correlators as new data objects are retrieved from and/or stored in the data store 228. In this example, the invocation contains a function call to the serializer 220 to retrieve data from the data store 228. The function call contains the query statement(s) or scripts from the execution plan, to retrieve data from the data store 228.

The function call also contains a unique ID (e.g., a P_GUID) of the mapper 210 as the invoking entity. The P_GUID is determined by the process ID correlator 212 from the metadata of the function call from the mapper 210 to the serializer 220 to retrieve the data. The data ID correlator 222 may also query a configuration file to determine the P_GUID.

At stage C, the provenance unit 218, in response to the function call, queries the data store 228 for a source data 234. The source data 234 may have an associated metadata that identifies the source data's 234 various characteristics (e.g., a data globally unique ID (GUID), owner(s) of the data, etc.) and other information describing the attributes of the source data 234. Some or all of the metadata may also be generated and/or determined by a component or system such as the data ID correlator 222 and/or the streaming manager 230. In this example, an ID for the source data 234 (i.e., a D_GUID_SOURCE) is generated by the data ID correlator 222 and associated with an ID (i.e., an OWNER_ID) of the entity that has ownership rights to the source data 234. The OWNER_ID was generated when the source data 234 is initially stored in the data store 228. The owner of the source data 234 may be an enterprise, a user, etc.

At stage D, the serializer 220 converts a data object such as the source data 234 into a data stream. A data object is a representation of data stored in the data store 228. A data object may be a file, object, element, or a storage format used by the data store 228. A data stream 236 includes the data stream and an attribute that contains information about the data value in the data object (e.g., D_GUID_SOURCE). Serialization provides an efficient and customized representation of the data object for the MapReduce programs such as the mapper 210 and the reducer 214 in the processing unit 208.

The various components of the processing unit 208 and the provenance unit 218 such as the serializer 220 are instrumented with an agent to capture data generated by the components. In this example, the agent in the serializer 220 captures data while the serializer 220 is serializing the source data 234. The agent may be a software or hardware element that monitors the components (e.g., the serializer 220). The agent inserts probes into the bytecode of the components such as the serializer 220. Inserting the probes into the bytecode is part of the instrumentation process that enables the monitoring of the components dynamically during runtime. The bytecode instrumentation may be inserted at the worker threads of the components such that each invocation of the component can be monitored.

Correlators via the agent can monitor for events generated by the components. The data ID correlator 222 via the agent can monitor for specific events and/or information generated by the serializer 220. In this example, the data ID correlator 222 records the P_GUID, the D_GUID_SOURCE, that a function call was received, the time the function call was received, the OWNER_ID, the ID of the client 200 that initiated the initial request, the attributes or parameters provided with the function call, etc. The data ID correlator 222 forwards the collected information and/or metrics from the serializer 220 along with the D_GUID_SOURCE and the P_GUID (e.g., metrics 254) to the streaming manager 230. The data ID correlator 222 associates the D_GUID_SOURCE with the OWNER_ID. The data ID correlator 222 transmits the association as a record 252 to the streaming manager 230. In another example, the provenance components (e.g., the serializer 220 and the deserializer 224) associate the D_GUID_SOURCE with the OWNER_ID and transmit the association as the record 252 to the streaming manager 230.

At stage E, the serializer 220 transmits the data stream along with the D_GUID_SOURCE (e.g., the data stream 236) to the mapper 210 and invokes the processing unit 208 to begin processing the data stream. As stated earlier, the processing unit 208 is an implementation of a MapReduce framework. MapReduce is a framework and programming model to process data in a distributed way. The MapReduce framework provides efficient parallelization while abstracting the complexity of distributed processing. The MapReduce framework can partition the input data, schedule the execution of program across a set of machines and manage inter-machine communication. The MapReduce framework provides an abstraction by defining a mapper and a reducer. The mapper 210 generates a set of intermediate key/value pairs and the reducer 214 merges the intermediate keys.

As stated earlier, the mapper 210 is loaded with the process ID correlator 212. The pedigree processing components (e.g., the mapper 210 and the reducer 214) manage and/or keep track of the process ID. The processing components via the process ID correlators (e.g., the process ID correlator 212 and 216) executes functions such as generating and/or determining processor IDs, creating ID associations. The process ID correlator 212 monitors and/or collects metrics on the mapper 210 and transmit the metrics to the streaming manager 230. The process ID correlator 212 associates the P_GUID to the mapper 210 ID (e.g., an M210_GUID). The process ID correlator 212 transmits the association, as a record 244 to the streaming manager 230. In another example, the pedigree processing components transmit the association, as a record to the streaming manager 230. The process ID correlator 212 also transmits the metrics generated by the mapper 210 while creating a key value pair 238 along with the D_GUID_SOURCE and the P_GUID (e.g., a metrics 246) to the streaming manager 230.

At stage F, the mapper 210 invokes the reducer 214 to begin processing the key value pair 238. The mapper 210 transmits the key/value pair 238 along with the D_GUID_SOURCE and P_GUID to the reducer 214 with the invocation. Reducers merge the values associated with the same key and generate a set of values as an output (e.g., an output 240). As stated earlier, the reducer component 214 is loaded with the process ID correlator 216. The reducer component 214 via the process ID correlator 216 executes functions such as generating and/or determining IDs, creating ID associations. The process ID correlator 216 monitors and/or collects metrics on the reducer 214 and transmits the metrics to the streaming manager 230. The process ID correlator 216 associates the P_GUID to the processor ID (e.g., an R214_GUID) of the reducer 214. The process ID correlator 216 transmits the P_GUID with the R214_GUID in association as a record 248 to the streaming manager 230. In another example, the reducer 214 transmits the P_GUID with the R214_GUID in association as a record 248 to the streaming manager 230. The process ID correlator 216 also transmits the metrics generated by the reducer 214 while generating the output 240 along with the D_GUID_SOURCE and the P_GUID (e.g., a metrics 250) to the streaming manager 230.

At stage G, the reducer 214 invokes the deserializer 224 to begin processing the output 240. Deserializers takes data streams and converts them to a data object. As stated earlier, the deserializer 224 is loaded with the data ID correlator 226. The deserializer 224, via the data ID correlator 226 executes functions such as generating and/or determining IDs, creating ID associations. The data ID correlator 226 monitors and/or collects metrics on the deserializer 224 and transmits the collected metrics to the streaming manager 230. The deserializer 224 via the data ID correlator 226 generates an ID (e.g., a D_GUID_RESULT) for the de-serialized data object (e.g., a result data 242). The deserializer 224 via the data ID correlator 226 associates the D_GUID_RESULT with the OWNER_ID. The deserializer 224 via the data ID correlator 226 transmits the D_GUID_RESULT and the OWNER_ID association as a record 256 to the streaming manager 230. The data ID correlator 226 also transmits the metrics generated by the deserializer 224 while de-serializing the output 240 along with the D_GUID_RESULT and the P_GUID (e.g., a metrics 258) to the streaming manager 230.

At stage H, the streaming manager 230 writes the record 256 and the metrics 258 to the streaming manager data store 232. Stage H is representative of the stage of writing the associations as the records (e.g., the records 244, 248 and 252) and the metrics (e.g., the metrics 246, 250, and 254) to the streaming manager data store 232 by the streaming manager 230 after receipt of each of the respective associations and/or the metrics from the components and/or the correlators.

At stage I, the provenance unit 218 transmits result data 242 to the system interface 206 to be transmitted to the client 200 that initiated the request 233. The result data 242 is a CSV file containing the response of the analytics system 204 to the request 233.

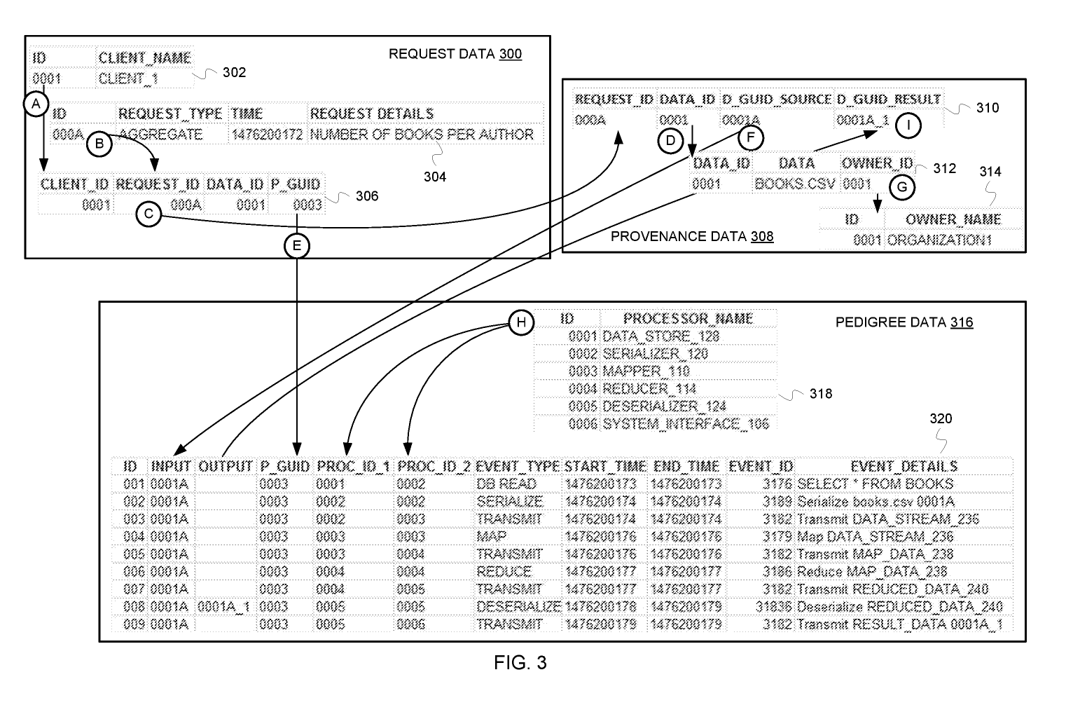

FIG. 3 depicts an example portion of the streaming manager data store 232. The example portion depicts information recorded during the execution of the data analytics request 233 in FIG. 2. The information is presented in tables. The tables are grouped into a request data 300, provenance data 308, and pedigree data 316. The group request data 300 contains a client table 302, a request table 304 and a linking table 306. The group provenance data 308 contains a linking table 310, a data properties table 312, and an owner table 314. The group pedigree data 316 contains a processor table 318 and an events table 320. The grouping, logical association, and presentation of the information such as between table entries in a given table record in the depicted tables is merely for ease of explanation. A data structure or data structures used to implement the data store can vary (e.g., files, multi-dimensional array, linked list of entries in order of time instant, relational database, etc.). In addition, the organization of information can vary. A repository can group the information by the correlator, component, request, etc.

FIG. 3 is annotated with a series of letters A-I. These letters represent associations between the information depicted in the tables. Although these associations are ordered for this example, the associations illustrate one example to aid in understanding this disclosure and should not be used to limit the claims. Subject matter falling within the scope of the claims can vary with respect to the order of some of the associations.

Upon receipt of a request from a client, a data entry in a request table 304 is recorded as a request ID 000A. In this example, the request table 304 has an ID columnar field that indicates the request ID as the primary table record key. The primary key uniquely identifies each request received. A primary key can also be a combination of different properties of the request, such as a request type with a time stamp. The depicted row-wise record entry of a linking table 306 includes mutually associated fields CLIENT_ID, REQUEST_ID, DATA_ID, and P_GUID that logically associate the request to the client table 302, the linking table 310, and the events table 320. Linking tables use foreign keys to form the logical association between among the tables. These relationships are used to associate relational tabular information among the different tables. The tables may be joined when correlating the information to present a report to users for example.

Association A depicts the ID field in client table 302 and the CLIENT_ID field in linking table 306 as a link between the client table 302 and the linking table 306. The linking table 306 includes table record entry 000A as associated within a table record with field entry 0001 that the REQUEST_ID 000A was initiated by a CLIENT_ID 0001. Association A identifies the CLIENT_ID 0001 as a CLIENT 1. Association B depicts a REQUEST_ID in the linking table 306 as a link between the request table 304 and the linking table 306. The request table 304 shows the properties of the request 000A, such as the request type and the request details.

Association C depicts the relationship of the linking table 306 to the linking table 310 via the REQUEST_ID as a foreign key. Association D links the DATA_ID in the linking table 310 to the DATA_ID of the data table 312. The linking table 310 tracks the source data used in servicing requests such as the REQUEST_ID 000A. As mentioned earlier, the data ID correlator 222 generated a D_GUID_SOURCE to identify the source data 234 retrieved from the data store 228. This D_GUID_SOURCE is stored in the D_GUID_SOURCE column of the linking table 310. Association E depicts the relationship of the linking table 306 to the events table 320 via the foreign key P_GIUD.

Association F shows a DATA_ID 0001 retrieved by the serializer from the data store is associated to a D_GUID_SOURCE 0001A which is used as input in the events table 320. The association G shows that the DATA_ID 0001 is associated with an OWNER_ID 0001. The OWNER_ID 0001 is the owner of the data as depicted in the data properties table 312. The OWNER_ID 0001 identifies an ORGANIZATION1 as the owner as depicted in the owner table 314.

An events table 320 shows the events and/or metrics collected by the process ID correlators and the data ID correlators from the various pedigree processing components and storage components in the processing and storage pipeline. As mentioned earlier the P_GUID identifies the entity that initiated the processing of the request. The linking table 306 shows the association of the P_GUID 0003 with the REQUEST_ID 000A. The P_GUID 003 is used to track the processing of the D_GUID_SOURCE 001A through the various pedigree processing and storage components in the processing and storage pipeline as depicted in the events table 320. Association H links the pedigree processing component (e.g., processing component) IDs in the events table 320 to the processor table 318 that contains the names of the pedigree processing components in the processing pipeline.

As stated earlier, the deserializer 224 via the data ID correlator 226 generated a D_GUID_RESULT 0001A_1 to identify the output received from the processing unit 208. Association I depict the association of the D_GUID_RESULT 0001A_1 to the D_GUID_SOURCE 0001A and the REQUEST_ID 000A.

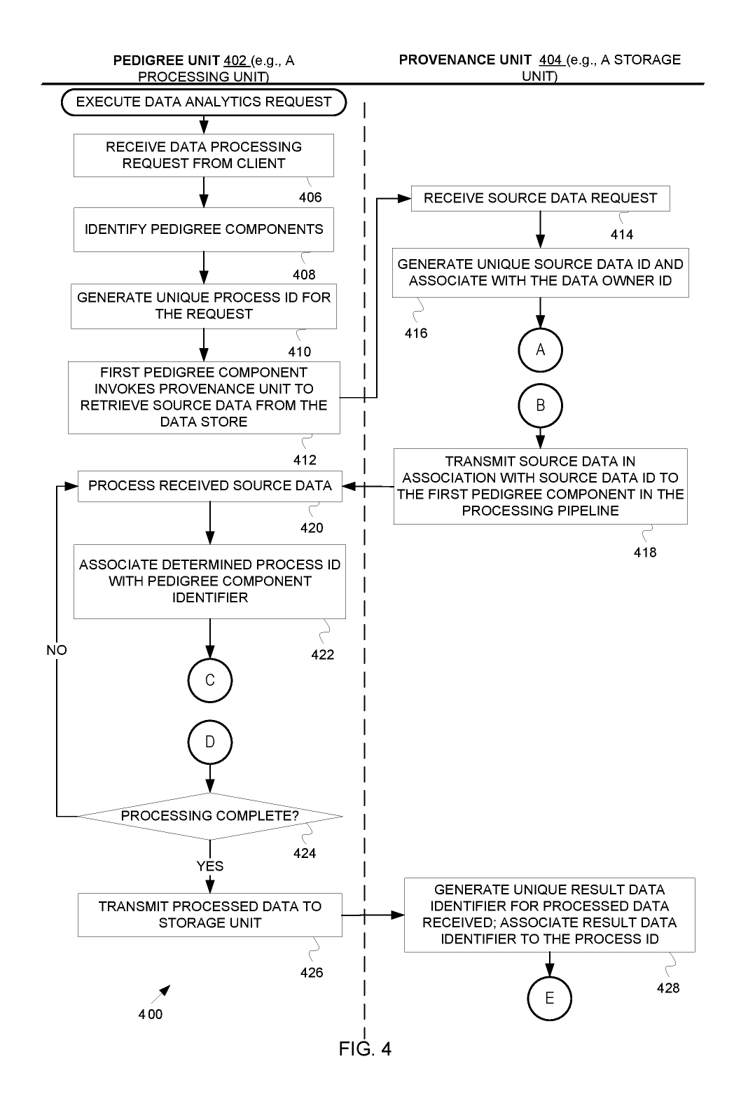

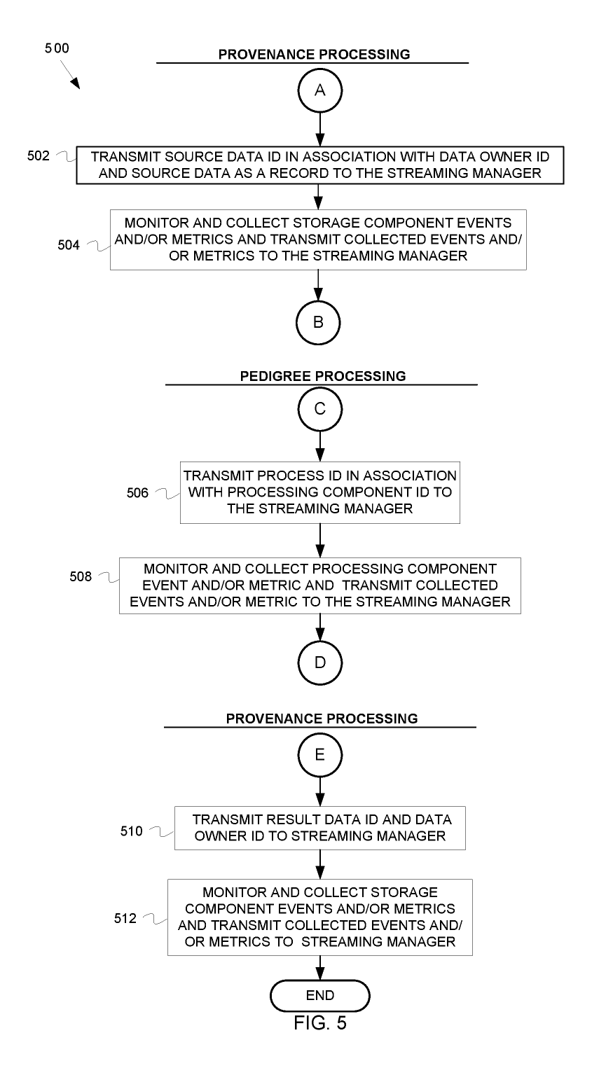

FIGS. 4 and 5 depict flowcharts for executing a data analytics request. A flowchart 400 of FIG. 4 refers to a pedigree processing pipeline and a storage unit as performing the example operations for consistency with FIG. 2. A flowchart 500 of FIG. 5 refers to process ID correlators 212 and 216 and data ID correlators 222 and 226 of FIG. 2 as performing the example operations for consistency with FIG. 2. Operations of the flowcharts 400 and 500 continue between each other through transition points A-E.

The pedigree processing pipeline receives a data processing request from a client (406). A data processing request maybe made by a client, a component or a unit (e.g., interface unit, provenance unit, etc.). A client may be an application, a web service, a user, etc. A request may be submitted through various means such as through a method call, a command received via a command line, or an application program interface (API) call. The pedigree processing includes designated processing components such as mapper 210 and reducer 214 that are programmed to listen for request notifications. The processing components within the processing pipeline execute the relevant data processing or analysis to service a client request that may entail multiple data processing steps. The individual steps and sequence of step may be determined based on an execution plan generated by a compiler and/or one or more of the components within the processing pipeline. The processing pipeline may be an implementation of a data processing paradigm such as MapReduce, spanning tree, etc. The processing pipeline may be comprised of at least one pedigree processing component on a machine or across a cluster of machines. A pedigree processing component is a non-storage processing component that may processing input data to generate result data that differs from the input data. Not all processing components may be pedigree processing components. The pedigree processing component may be characterized as having been identified as belong to a set of one or more processing components within a designated pedigree processing component set. For example, in a MapReduce paradigm, a master component may not be specified as a pedigree processing component but a mapper and reducer may be identified as belong to a designated pedigree component set.

Upon receipt of the request, the pedigree pipeline assigns the request to a processing component in accordance with a defined algorithm or an execution plan. For example, the pedigree pipeline assigns the request to an idle component such as a master instance in a MapReduce framework for processing. A process ID correlator and/or a data ID correlator may be loaded within pedigree components and/or provenance components such as by bytecode injection. The loading may be performed during startup or when the component is deployed. A correlator may also be loaded dynamically, such as when a component is invoked. A correlator may also be loaded on certain components in accordance to certain rules such as if components are assigned a pedigree processing designation flag. A component that is assigned as belong to a pertinent pedigree or provenance set (e.g., a mapper or a storage component) may be assigned with an ID designator that identifies the component as being either a pedigree processing component or a provenance component.

The pedigree processing system identifies the pedigree components available for assignment (408). The pedigree system may identify the pedigree components using a configuration file, clustering analysis, or by performing a query such as via a method or API call, etc. After identifying the pedigree components, the pedigree processing system assigns a pedigree component to initiate the data processing. The pedigree component via the process ID correlator of the assigned pedigree component may determine a unique process ID to track the request through the processing pipeline from a data origin or source to a derived artifact (410). The process ID may also be determined by another entity or correlator such as the pedigree unit, a request tracker component and/or correlator, etc. The process ID may be based on the processor ID of the component (e.g., the master instance) initially assigned to process the request, a request ID, etc. The processor ID may also be a randomly generated globally unique identifier (GUID). The process ID may be managed by the pedigree component assigned to initiate the data processing. In other embodiments, the process ID may be managed by a correlator, pedigree unit, a component (e.g., a request tracker), etc.

Upon receipt of the data analytics request, the assigned pedigree component invokes the storage unit 404 to retrieve a source data from the data store for processing (412). The invocation may include the process ID, client ID, type of request, uniform resource locator, etc. The invocation may also include a query statement from the execution plan generated by a compiler. The invocation may be a function call to the provenance unit or a component in the provenance unit. If the invocation is a function call to the provenance unit, the provenance unit directs the request to a provenance component.

Upon receipt of the source data request (414), the storage unit 404 assigns the function call to a provenance component, wherein the provenance component retrieves the source data from the data store. The storage unit 404 may be comprised of at least one provenance component on a machine or across a cluster of machines. A provenance component may be a data storage component. Not all storage components may be identified as a provenance component. The provenance component may be a storage component that is specified as a provenance component. For example, in a distributed file system, a query processor component may not be specified as a provenance component but a serializer and a deserializer may be specified as a provenance component.

Various methodologies may be used to retrieve and store the data from the data store such as via an application, web service, interface (e.g., Java Database Connectivity (JDBC) API, Representational State Transfer (REST) API), etc. The storage unit 404 may include a reader and a writer implementation to access the data store. The storage unit 404 may be either a relational database, a NOSQL database, a distributed file system, etc.

The invoked provenance component, via the data ID correlator generates a unique source data identifier for the retrieved source data and associates the source data identifier to a data owner ID (416). The data ID correlator may determine the OWNER_ID using various means such via the name of the owner indicated in a function call (e.g., a MapReduce job metadata). The owner may also be the originating entity (e.g., the originating pedigree component) of the source data identified in the data store such as via an associated metadata. The originating entity of the source data may be determined from the usage rules and/or derivation rules associated with the source data. Finally, the data owner ID may have been determined as an entity that has the ownership rights of the source data during the initial storage of the source data. The entity that has ownership rights may be the creator, the organization that stored the source data, the data consumer, or as determined by a service level agreement (SLA) when the source data was initially stored. The source data ID may also be determined from a data ID when the source data was initially stored in the data store or repository such as an index or a GUID. If there is no data owner ID for the source data, the data ID correlator may generate a unique owner ID and associate it with the source data. The data ID correlator may also generate the OWNER_ID to meet a format specified by the pedigree processing system, the storage unit 404 and/or a streaming manager. Operations of the flowchart 400 continue at a transition point A, which continues at transition point A of the flowchart 500.

Operations of the flowchart 500 from the transition point A is now described. From the transition point A, operations of the flowchart 500 continue at block 502. The data ID correlator transmits the source data ID and the data owner ID association as a record to the streaming manager (502). The data ID correlator may also transmit an additional ID such as the request ID to the streaming manager. The streaming manager may be a big data streaming framework that processes data in real time (e.g., Apache Spark® processing engine), wherein the receipt of the information from correlators is continuous. The storage and/or processing of received information to a data store may also be continuous such as using “continuous queries” and/or streaming analytics. The streaming manager may also store and/or process the data received in batches. For example, the data streaming manager may not store all received data, or data may be aggregated before it is stored. The data streaming manager may also have a front end for a continuous live view of streaming data. A live analytics front end may process the streaming data in real time to create real-time reports. In addition, reports based on historical data stored in the streaming manager data store may also be generated. For example, the report (e.g., a data pedigree report, a data provenance report, etc.) may be based on the consolidation of the reported associations and/or metrics, etc. pertaining to a source data ID, process ID, request ID, etc.

The data ID correlator monitors and/or collects provenance component events and/or metrics and transmits the collected events and/or metrics to the streaming manager (504). The events may be generated by the agents or probes on the components, hardware or software modules of the components, etc. The data ID correlator may send the collected events to the streaming manager in real-time. For example, each event may be streamed to the streaming manager at the time the event was collected. The data ID correlator may send the events to the streaming manager through a designated interface or port using a communication protocol. For example, the data ID correlator may send an event as an HTTP message through a port reserved for communication from correlators. The communication may include an identifier of the component that is loaded with the data ID correlator that sent the information to the streaming manager. Information about the event includes an event type/code, process ID, start time of the event, end time of the event, event ID, event description, etc.

The data ID correlator may send the collected metrics or events to an event communication bus. The event communication bus may include a component that receives and stores events in a buffer, such as a first-in-first-out (“FIFO”) buffer, located in memory or on a storage device. The event communication retains received events until they are transmitted to a streaming manager or a component. In an alternative, the collection streaming manager or the component may read the events in the communication bus.

Operation of the flowchart 500 continues at transition point B, which continues at a transition point B of the flowchart 400. From the transition point B of the flowchart 400, operations return to the storage unit 404. Operations of flowchart 400 from the transition point B is now described. After retrieving the source data from the data store, the storage unit 404 transmits the source data in association with the source data ID to the pedigree processing system for analysis and/or processing (418). The storage unit 404 associates the source data with the source data ID prior to transmission. The storage unit 404 may pre-process the data prior to transmitting the source data to the pedigree processing system. For example, the storage unit 404 may remove headers, footers, etc. In addition, the storage unit 404 may serialize the source data prior to transmission.

After receiving the transmitted source data, the pedigree processing system starts processing the received source data (420). The pedigree processing system may process the received source data according to an execution plan. In addition, the pedigree processing system may also process the received source data according to data derivation rules (e.g., limitation on generation of derived data or result data from the source data), and/or usage rules (e.g., restrictions imposed by the owner of the source data), etc. The pedigree processing system assigns a pedigree component to execute a function according to the execution plan and/or rules. For example, the master instance in a MapReduce paradigm may assign the source data to a mapper function component. The assigned pedigree component via the process ID correlator associates the process ID with the processor ID of the currently assigned pedigree component (422). The assigned pedigree component is the pedigree component currently executing an action or function to the source data. The processor ID of the currently assigned pedigree component may be determined by a command issued via the command line interface, a method call, GUID, etc. In other embodiments, the association may be between the process ID and another unique ID of the currently assigned pedigree component. Operations of the flowchart 400 continue at a transition point C, which continues at the transition point C of the flowchart 500.

Operations of the flowchart 500 from the transition point C is now described. From the transition point C, operations of the flowchart 500 continue at a block 506. Similar to the block 502, the process ID correlator transmits the process ID and the processor ID association as a record to the streaming manager (506). Similar to the block 504, the process ID correlator monitors and collects events from the assigned pedigree component. The process ID correlator transmits the collected events and/or metrics to the streaming manager (508). For example, a probe can provide various data (e.g., event start time, error(s) generated, etc.) to an agent included in the process ID and/or the data ID correlators. Based on the data received from the probes, the agent and/or the correlator can determine a metric. For instance, the agent and/or the correlator can calculate the execution time of the mapper function. Similar to a data ID correlator, the process ID correlator may determine whether to transmit the data and/or the metric to the streaming manager. This determination may be based on an attribute set in the streaming manager and/or the pedigree processing system. The attributes may have default settings (e.g., collect time stamps) which can be altered by a user, administrator and/or the application. The pedigree unit and/or provenance ID correlator can collect and summarize information received from other agents and/or correlators. A single component can be monitored by one or more correlators. A single correlator can monitor more than one component. The streaming manager may be programmed to read the data sent by the correlator as a data stream or in batches. Similar to the block 502, the streaming manager may transmit the data received to the data store as a stream or in batches. The streaming manager may also pre-process the data received before transmitting it to the data store. Similar to the data store of the provenance unit, the streaming manager data store may store the information in a relational database, NoSQL database or a distributed file system. The streaming manager maintains the information in the streaming manager data store. Similar to the storage unit 404, the streaming manager may also have a read/write application implemented to access the streaming manager data store. The streaming manager may receive events in accordance with an API. The events may be received in real time as a data stream or in batches. The batch size may vary based on a configuration or performance limitations of the streaming manager. The streaming manager may retrieve events in a FIFO order.

Operation of the flowchart 500 continues at a transition point D, which continues at the transition point D of the flowchart 400. From the transition point D of the flowchart 400, operations return to the pedigree processing system. Operations of the flowchart 400 from the transition point D is now described. The pedigree unit determines if the processing of the data is complete (424). A component such as a master instance in a MapReduce paradigm may determine if processing is complete. The determination may be according to an execution plan, for example. If processing of the source data is not complete, control returns to the block 420, wherein the data (e.g., an intermediate data, wherein the source data has some processing done or has been transformed) is transmitted to the next pedigree component in the processing pipeline for processing. If the processing is complete, the processed or result data is transmitted to the storage unit 404 (426).

Similar to the block 416, the data ID correlator of the invoked provenance component generates a unique source data identifier for the processed or result data. The provenance component via the data ID correlator associates the result data identifier to the process ID generated by at the block 410 (428). The provenance component via the data ID correlator may also associate the result data ID to the data owner ID. The owner of the processed data may be the same as the owner of the source data. In other embodiments, the owner of the processed data may be another entity. Operations of the flowchart 400 continue at a transition point E, which continues at the transition point E of the flowchart 500.

Operations of the flowchart 500 from transition point E is now described. From transition point E, operations of the flowchart 500 continue at the block 510. Similar to the block 502, the data ID correlator transmits the result data ID and the process ID as a record to the streaming manager (510). If the result ID is also associated with the owner ID, then the data ID correlator also transmits the result ID and the owner ID association as a record to the streaming manager. Similar to block 504, the data ID correlator monitors and collects events and/or metrics of the invoked provenance component and transmits the collected events and/or the metrics to the streaming manager (512).

Variations

The above examples refer to an analytics system paradigm such as MapReduce. The data analysis (e.g., searching for specific data, searching for patterns of data, retrieving data, etc.) can be performed with various learning as well as custom algorithmic concepts, such as regression, classification, clustering, and model-based recommendations. The same algorithms can also be translated to other analytic system algorithms such as MapReduce algorithms before a request is processed.

The examples often refer to a “component.” The component is a construct used to refer to implementation of functionality for handling (e.g., processing, storage, etc.) data. This construct is utilized since numerous implementations are possible. Although the examples refer to operations being performed by a component, different entities can perform different operations. For instance, a dedicated co-processor or application specific integrated circuit can process data.

The examples often refer to various “agents”, “correlators” and a “streaming manager.” The agents, correlators, and the streaming manager are constructs used to refer to implementation of functionality for a tracking system that collects events and/or metrics. These constructs are utilized since numerous implementations are possible use of the constructs allow for efficient explanation of content of the disclosure. Although the examples refer to operations being performed by an agent, correlator or streaming manger, different entities can perform different operations. For instance, a different program can be responsible for maintaining the events and/or metrics repository while the streaming manager interacts with correlators to control the behavior of the correlators and/or agents.

The flowcharts are provided to aid in understanding the illustrations and are not to be used to limit the scope of the claims. The flowcharts depict example operations that can vary within the scope of the claims. Additional operations may be performed; fewer operations may be performed; the operations may be performed in parallel; and the operations may be performed in a different order. For example, the operations depicted in blocks 506 and 508 can be performed in parallel or concurrently. It will be understood that each block of the flowchart illustrations and/or block diagrams, and combinations of blocks in the flowchart illustrations and/or block diagrams, can be implemented by program code. The program code may be provided to a processor of a general-purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of the platform (operating system and/or hardware), application ecosystem, interfaces, programmer preferences, programming language, administrator preferences, etc.

Any combination of one or more machine readable medium(s) may be utilized. The machine-readable medium may be a machine-readable signal medium or a machine-readable storage medium. A machine-readable storage medium may be, for example, but not limited to, a system, apparatus, or device, that employs any one of or a combination of electronic, magnetic, optical, electromagnetic, infrared, or semiconductor technology to store program code. More specific examples (a non-exhaustive list) of the machine-readable storage medium would include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain, or store a program for use by or in connection with an instruction execution system, apparatus, or device. A machine-readable storage medium is not a machine-readable signal medium.

A machine-readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object-oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine-readable medium that can direct a machine to function in a particular manner, such that the instructions stored in the machine readable medium produce an article of manufacture including instructions which implement the function/act specified in the flowchart and/or block diagram block or blocks.

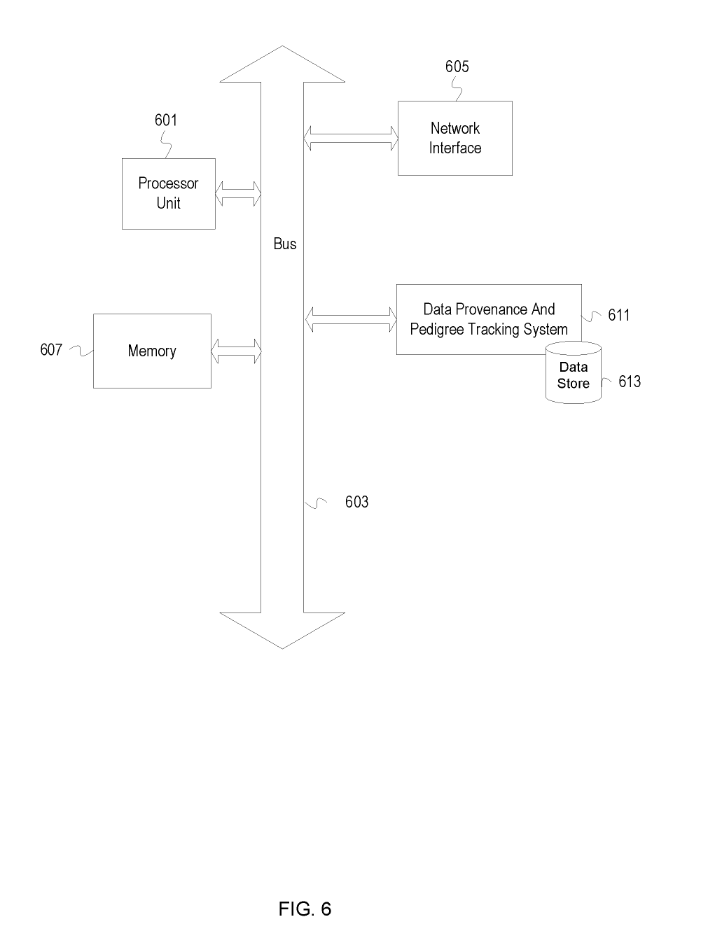

FIG. 6 depicts an example computer system with a data provenance and pedigree tracking system. The computer system includes a processor unit 601 (possibly including multiple processors, multiple cores, multiple nodes, and/or implementing multi-threading, etc.). The computer system includes memory 607. The memory 607 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 603 (e.g., PCI, ISA, PCI-Express, HyperTransport® bus, InfiniBand® bus, NuBus, etc.) and a network interface 605 (e.g., a Fiber Channel interface, an Ethernet interface, an internet small computer system interface, SONET interface, wireless interface, etc.). The system also includes the data provenance and pedigree tracking system data store 613. The data provenance and pedigree tracking system data store 613 can be a hard disk drive, such as a magnetic storage device. Any one of the previously described functionalities may be partially (or entirely) implemented in hardware and/or on the processor unit 601. For example, the functionality may be implemented with an application specific integrated circuit, in logic implemented in the processor unit 601, in a co-processor on a peripheral device or card, etc. Further, realizations may include fewer or additional components not illustrated in FIG. 6 (e.g., video cards, audio cards, additional network interfaces, peripheral devices, etc.). The processor unit 601 and the network interface 605 are coupled to the bus 603. Although illustrated as being coupled to the bus 603, the memory 607 may be coupled to the processor unit 601.

While the aspects of the disclosure are described with reference to various implementations and exploitations, it will be understood that these aspects are illustrative and that the scope of the claims is not limited to them. In general, techniques for data provenance and pedigree tracking system as described herein may be implemented with facilities consistent with any hardware system or hardware systems. Many variations, modifications, additions and improvements are possible.

Plural instances may be provided for components, operations or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

### Terminology

The term “agent” as used in the application refers to a process or device for monitoring a component. An agent may be program code that executes on resources of a component or may be a hardware probe. An agent monitors a component to measure and report data provenance, pedigree, and usage rules, such as origin, nature of processing, rights of data owners, authorization for processing, etc. A component may be instrumented with an agent by installing a hardware probe on the component or by initiating a process on the component that executes program code for the agent.

The term “component” as used in this application encompasses both hardware and software resources. The term component may refer to a physical device such as a computer, server, router, etc.; a virtualized device such as a virtual machine or virtualized network function; or software such as an application, a process of an application, database management system, etc. A component may include other components. For example, a server component may include a web service component which includes a web application component.

This description uses the term “data stream” to refer to a unidirectional stream of data flowing over a data connection between two entities in a session. The entities in the session may be interfaces, services, etc. The elements of the data stream will vary in size and formatting depending upon the entities communicating with the session. Although the data stream elements will be segmented/divided according to the protocol supporting the session, the entities may be handling the data at an operating system perspective and the data stream elements may be data blocks from that operating system perspective. The data stream is a “stream” because a data set (e.g., a volume or directory) is serialized at the source for streaming to a destination. Serialization of the data stream elements allows for reconstruction of the data set. The data stream is characterized as “flowing” over a data connection because the data stream elements are continuously transmitted from the source until completion or an interruption. The data connection over which the data stream flows is a logical construct that represents the endpoints that define the data connection. The endpoints can be represented with logical data structures that can be referred to as interfaces. A session is an abstraction of one or more connections. A session may be, for example, a data connection and a management connection. A management connection is a connection that carries management messages for changing the state of services associated with the session.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

What is claimed is:

1. A method comprising:
in response to a request from a processing component to access source data,
a data identifier (ID) correlator generating a source data ID, wherein the data ID correlator is loaded in a storage component; and
transmitting the source data in association with the source data ID to the processing component;
the processing component processing the source data to generate result data;
a process ID correlator that is loaded in the processing component,
generating a process ID;
transmitting the result data in association with the process ID and the source data ID to a streaming manager;
transmitting the process ID in association with the processing component ID to the streaming manager; and
the streaming manager linking the association of the result data with the process ID and the source data ID with the association of the processing component ID with the process ID.

2. The method of claim 1, further comprising transmitting the result data in association with the process ID and the source data ID to the storage component.

3. The method of claim 1, further comprising:
generating the request to access source data based on a client request received by a data set processing system that includes the processing component; and
the streaming manager linking a client request ID associated with the client request to the source data ID.

4. The method of claim 1, further comprising:
the data ID correlator,
generating a result data ID for the result data; and
transmitting the process ID in association with the result data ID to the streaming manager; and
the streaming manager generating one or more table records that associate the result data ID with the source data ID and the process ID.

5. The method of claim 1, further comprising:
the data ID correlator,
associating the source data ID with an owner ID, wherein the owner ID is further associated with usage rules for the source data; and
transmitting the source data ID and the owner ID to the streaming manager.

6. The method of claim 1, further comprising:
the data ID correlator and the process ID correlator monitoring a metric of each component of a provenance unit and a pedigree unit respectively from a plurality of metrics; and
the data ID correlator and the process ID correlator transmitting the metric along with the source data ID or result data ID and the process ID to the streaming manager.

7. The method of claim 1, wherein the data ID correlator and the process ID correlator comprise bytecode injected instrumentation.

8. One or more non-transitory machine-readable storage media comprising program code for managing data, the program code to:
in response to a request from a processing component to access source data,
generate a source data ID; and
transmit the source data in association with the source data ID to the processing component;
process the source data to generate result data;
generate a process ID;
transmit the result data in association with the process ID and the source data ID to a streaming manager;
transmit the process ID in association with the processing component ID to the streaming manager; and
link, within relational tables of the streaming manager, the association of the result data with the process ID and the source data ID with the association of the processing component ID with the process ID.

9. The machine-readable storage media of claim 8, wherein the program code further comprises program code to transmit the result data in association with the process ID and the source data ID to the storage component.

10. The machine-readable storage media of claim 8, wherein the program code further comprises program code to:
generate the request to access source data based on a client request received by a data set processing system that includes the processing component; and
link, within the streaming manager, a client request ID associated with the client request to the source data ID.

11. The machine-readable storage media of claim 8, wherein the program code further comprises program code to:
generate a result data ID for the result data; and
transmit the process ID in association with the result data ID to the streaming manager; and
generate one or more table records that associate the result data ID with the source data ID and the process ID.

12. The machine-readable storage media of claim 8, wherein the program code further comprises program code to:
associate the source data ID with an owner ID, wherein the owner ID is further associated with usage rules for the source data; and
transmit the source data ID and the owner ID to the streaming manager.

13. The machine-readable storage media of claim 8, wherein the program code further comprises program code to:
monitor a metric of each component of a provenance unit and a pedigree unit respectively from a plurality of metrics; and
transmit the metric along with the source data ID or result data ID and the process ID to the streaming manager.

14. An apparatus comprising:
a processor; and
a machine-readable medium having program code executable by the processor to cause the apparatus to,
in response to a request from a processing component to access source data,
generate a source data ID; and
transmit the source data in association with the source data ID to the processing component;
process the source data to generate result data;
generate a process ID;
transmit the result data in association with the process ID and the source data ID to a streaming manager;
transmit the process ID in association with the processing component ID to the streaming manager; and
link, within the streaming manager, the association of the result data with the process ID and the source data ID with the association of the processing component ID with the process ID.

15. The apparatus of claim 14, wherein the program code further comprises program code executable by the processor to cause the apparatus to transmit the result data in association with the process ID and the source data ID to the storage component.

16. The apparatus of claim 14, wherein the program code further comprises program code executable by the processor to cause the apparatus to:
generate the request to access source data based on a client request received by a data set processing system that includes the processing component; and
link, within the streaming manager, a client request ID associated with the client request to the source data ID.

17. The apparatus of claim 14, wherein the program code further comprises program code executable by the processor to cause the apparatus to:
generate a result data ID for the result data; and
transmit the process ID in association with the result data ID to the streaming manager; and
generate one or more table records that associate the result data ID with the source data ID and the process ID.

18. The apparatus of claim 14, wherein the program code further comprises program code executable by the processor to cause the apparatus to:
associate the source data ID with an owner ID, wherein the owner ID is further associated with usage rules for the source data; and
transmit the source data ID and the owner ID to the streaming manager.

19. The apparatus of claim 14, wherein the program code further comprises program code executable by the processor to cause the apparatus to:
monitor a metric of each component of a provenance unit and a pedigree unit respectively from a plurality of metrics; and
transmit the metric along with the source data ID or result data ID and the process ID to the streaming manager.

20. The apparatus of claim 14, wherein said generating a source data ID and transmitting the source data in association with the source data ID to the processing component data are performed by a data ID correlator that comprises bytecode injected instrumentation.
